(19) United States
(12) Patent Application Publication
(10) Pub. No.: US 2019/0371127 A1
(43) Pub. Date: Dec. 5, 2019

(54) PARIWAGER GAMING METHOD USING PRE-COMPILED TEAMS

(71) Applicant: Jeffrey Scott SALVATI, La Vegas, NV (US)

(72) Inventor: Jeffrey Scott SALVATI, La Vegas, NV (US)

(21) Appl. No.: 16/206,585

(22) Filed: Nov. 30, 2018

Related U.S. Application Data
(60) Provisional application No. 62/679,737, filed on Jun. 1, 2018.

(51) Int. Cl. G07F 17/32

(52) U.S. Cl. CPC G07F 17/3288; G07F 17/3276; G07F 17/3244

(57) ABSTRACT

A method for playing a parimutuel betting game whose outcomes are determined by a scoring algorithm which translates the statistics of athletes that are pre-complied onto teams to be wagered upon. A host first conducts the compilation of teams based upon a year-to-date scoring average derived for each player thus creating a field of teams on which to wager. Next, betting windows are opened in each betting event for each team. Bettors can then bet money during the pendency of the window and receive a validated bet from a validator. The betting line will fluctuate upwards and downwards based upon the total amount of money wagered on each team. Upon closing the betting window, the final odds will be those odds applicable to the team on which the player has wagered. When a termination event occurs in the sporting event or series of sporting events for a given betting event, the betting event is terminated, and all winners are paid off in parimutuel style.

### CLAIM OF PRIORITY

This application claims the benefit of priority to U.S. Provisional Application No. 62/679,737, filed Jun. 1, 2018, the contents of which are incorporated herein by reference in its entirety.

### FIELD OF THE INVENTION

The present invention relates to parimutuel games for sporting events. More specifically, the invention relates to a gaming method using pre-compiled teams of athletes from sporting events, where athletes generate statistics for deterministic outcomes once those statistics are placed through a scoring algorithm.

### BACKGROUND

Many people watch sporting events for relaxation and the pleasure of rooting for their favorite team or their favorite players. As they watch the games, they form opinions on which teams are best, which players are best, and what teams in an athletic contest are more likely to win. Often, their enjoyment of watching a sporting event is increased by the ability to place a wager, enter a contest, or in some other manner engage in the sporting event or players participating in the sporting event. Excitement is further increased by the prospect of receiving a monetary reward if their selected team or players from selected teams wins the sporting event, or in the case of fantasy sports, when the individual players and their positions perform at a high level. Companies in several jurisdictions, both domestic and foreign, accept wagers on sporting events and operate contests on sporting events, which has created the advent of daily fantasy sports.

The simplest form of betting on sporting events is selecting the winners of each contest. This is not efficient for an operating entity collecting bets because one team may be more likely to win the sporting event than the other team. In this case, more bettors will most likely place bets on the perceived superior team, and the operating entity has the potential to lose money if the more highly-bet team wins. This problem was addressed in the industry by offering varying odds for the different participants in a sporting event, so that when the team perceived by the majority of the bettors to be superior emerged as the victor in the sporting event, the bettor would receive a lower return than when the team perceived to be less likely to win emerged as the victor.

Another way operating entities, also referred to as bet processing entities, attempt to balance wagering on both contestants of the sporting event is to add a handicap of a certain number of points to one team for each contest. In this form of wagering, the perceived superior team must win by a pre-selected number of points for the wager to be considered successful on the better team. If the perceived better team won by less than the number of points in the handicap, then it would lose the wager. Likewise, if the team perceived to be worse lost by fewer points than the handicap, bettors selecting that team would win the wager. For this type of wager, the payout returned to the bettor will be the same whether the team perceived to be superior or the team perceived to be inferior has the most points in the contest after adjusting for the added points. This method of accepting wagers is currently the most popular in the legal bookmaking industry.

Many bettors would like the chance to receive a higher payoff for their bets. To offer a higher payoff, the bookmaking entity must increase the level of difficulty in winning the bet. One solution by the bet processing industry was to require bettors to select the winners of multiple games, rather than just one game. If any contestant selected by the bettor lost, the bettor would lose that entire bet. But if all contestants selected by the bettor won their individual contests, the bettor would receive a much higher payoff. In one typical payout schedule, when the winners (after adjusting for points to balance both sides of the bet) of three games were selected correctly, then the bettor would win four dollars for each dollar bet. If four games were selected correctly, then the bettor would win eight dollars for each dollar bet. If fifteen games were selected correctly, then twenty-five thousand dollars would be won for each dollar bet. Picking the correct team in this many contests is very difficult for the bettor, but it is a very popular form of wagering because the small chance of getting a large return for a small bet appeals to many people. There is a disincentive for bet processing entities to offer larger payouts because in any given week there is a small chance that a bettor may select a large number of games correctly. If this were to happen, then the amount the bet processing entity would be required to pay out for the week might be far more than collected during that week. Even with the level of difficulty in choosing teams for the bettors and the potential catastrophic payout that might be required by the bet processing entity, this is a very popular bet.

Because the aforementioned methods of betting on sporting events, especially football games, is so popular, companies including non-bookmaking entities are constantly trying to develop new games for betting opportunities to engage the casual sports fan. A current example of this is the daily fantasy sports games offered by many game developers both domestic and foreign. In this game, a bettor is required to compile a team of athletes or players, called a fantasy team, chosen from an ambiguous pool of all players at specific positions typically associated with the fantasy team they are compiling, thus creating a roster of professional athletes specifically for the bettor. Each athlete on the bettor's roster scores points based on that athlete's individual performance. An example of a fantasy sports contest is “Will the Quarterback, Running Backs, Wide Receivers, Tight End, Defense and Special Teams chosen by the bettor resulting in his fantasy team score more points based upon individual performance than any other teams compiled by other bettors?” The popularity of fantasy sports like this demonstrate that people enjoy betting on sporting events, enjoy following their favorite players, and are looking for new ways to be engaged in sporting events.

An object of this invention is to provide a new way to engage in sporting events via fantasy sports games that is complementary to existing fantasy sports games and betting methods. The non-obvious nature of this method is affirmed by the fact that the teams of the type presented in this invention are not currently offered by any fantasy sports operators. Our teams are pre-compiled, thus eliminating the need for the bettor to compile a team and the need for the bettor to be knowledgeable on every player available in the pool of players. No other bookmaking establishment or game developer, even though it is in their best interest to offer as many different types of games as possible, is presently offering this format of fantasy sports.

Another popular form of gambling is betting on a parimutuel event. Examples of parimutuel events are a horse race, a jai alai game, and a dog race. Generally, these events have more than two participants. Contrast this to a team-based sporting event, such as a football game, where only two participants compete and there are only two potential outcomes. One team will win, and the other team will lose. After a winner of the team-based sporting event is determined the event is over and a new event begins. However, it is possible to create a betting opportunity that picks the best of the teams in a series of events. This process can be undertaken almost daily depending upon the type and number of like sporting events occurring on a given day. The game can also occur weekly, monthly, seasonally, or yearly. For example, U.S. style football traditionally has a regular season that occurs over the course of 17 weeks, with 32 teams competing each week over a five-day period (Thursday to Monday). While Team 1 will play Team 2 and a winner of that single game determines the outcome, one can envision a game that calls for Teams 1 through Team 32 to play against each other with the winners and finishing positions of all 32 teams determined by a scoring system applied to all the individual players at their respective positions based on their individual performance and then aggregated to derive the teams finishing position 1 through 32. Therein lies the ability to engage all participating teams for wagering or a contest.

Parimutuel betting is different than the fixed-price betting systems used in traditional Team 1 versus Team 2 sporting events betting. When a person makes a bet in a fixed-price system, he knows how much money he will be paid if he correctly selects the winner(s). In parimutuel betting, the amount that will be paid is determined by totaling all bets made and distributing this total amount bet (after deducting a fixed percentage for expenses and profit) equally among all bettors selecting the winning combination. This system has an operational advantage in that the operating entity cannot lose money on any individual bet. Because the betting public knows that the operating entity will always have the money to pay off any winning wagers from the proceeds of the current race, confidence in ability to collect large winning wagers is increased. This contrasts with the fixed-return bets on parlay cards, when an operating entity may be required to pay out more than it received in bets that week. The current fantasy sports games are contests whereby a bettor enters the contest for a stated dollar amount and the Operator pools those monies. As the games unfold and the contest bettors accumulate points via their fantasy team, they achieve a position among their peers. Because the operator guarantees certain winning dollar amounts based upon the finishing order of bettors, the operator is exposed to losses if the amount dispersed as winnings exceeds the dollar amount collected from the bettors of a contest. Because of the inherent feature of parimutuel betting where the operating entity is not at risk of being a net loser on any individual bet, contest or event, the operating entity is able to offer new bets with increasingly greater potential payouts to the bettors. Originally, bets offered at horse races consisted of Win (Select the horse that will finish first in a race), Place (Select a horse which will finish either First or Second in a race) and Show (Select a horse which will finish either First Second or Third in a race). The demand by bettors for larger payouts, even for the tradeoff of a lower probability of winning, led to the introduction of exotic bets. Exotic bets require the bettor to pick multiple horses in a race or a series of races. For instance, an exacta bet (Pick 2) requires the bettor to pick the horses that will finish first and second in the exact order. A trifecta bet (Pick 3) requires the bettor to pick the horses that will finish first, second and third in the exact order. A superfecta bet (Pick 4) requires the bettor to pick the horses that finish first, second, third and fourth in the exact order. Other bets are constantly being developed that offer even larger payouts for picking larger combinations of winners such as super six (Pick 6), picking the winners of 6 consecutive races, or the horse that will finish first, second, third, fourth, fifth and sixth in exact order. For betting opportunities where there is a possibility that no one will select all the winners, the proceeds of the betting pool are awarded to people picking most of the winners or carried over to the next similar betting event. In some cases, a portion of the betting pool is carried over to the next day or week, increasing the payout for the succeeding contest. Bets of this type are not currently possible for football, hockey, basketball and baseball games because there are only 2 participants in each game. When one team wins, the other team must lose so there is no way to bet other than picking one team to win, which also results in picking the other team to lose. By using a method of aggregating all games played in a period into one betting opportunity, this invention brings the possibility of parimutuel betting to football, basketball, baseball, hockey games, automobile races, soccer games, tennis matches, golf events, electronic sports (also commonly referred to as e-Sports) events and other entertainment mediums.

This invention overcomes limitations, both physical and psychological of current betting methods and fantasy sports games to create a game that involves some skill, but does not require extensive knowledge or pre-work on the part of the bettor. Furthermore, this invention has the potential of varying sizes of payouts to the bettor ranging from small to very large, in return for placing only a small bet and allows all bettors an equal chance of winning with little to no human intervention.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The claimed subject matter establishes a parimutuel betting method using straight and exotic betting methods including but not limited to win, place, show, pick 2, pick 3, pick 4, pick 5, and pick 6 (horserace-style bets), where the winning payoff is determined by pre-compiled teams for the bettor to choose. The pre-compiled teams are assembled from a sporting event or a series of sporting events and ranked by totaling the individual athletes' performance data according to a scoring matrix and algorithm. This is accomplished by combining several like sporting events into one betting opportunity and evaluating each participant in these sporting events with a common metric.

In one aspect of various exemplary embodiments, a method for parimutuel wagering is provided, the method comprising: acquiring a plurality of athlete statistics from a provider before a beginning of a sporting event; generating a plurality of pre-compiled teams using the plurality of athlete statistics; generating an initial odds for each of the pre-compiled teams; combining the initial odds and the pre-compiled teams for display to at least one bettor; displaying the pre-compiled teams with the initial odds for the at least one bettor to choose at least one of the teams upon which to wager a bet, whereby the initial odds becomes an interim odds that changes over regular intervals of time for the duration of a betting window; displaying to the at least one bettor a wager list for selecting a wager type; collecting at least one bet from the at least one bettor and providing a bet validation; closing the betting window at a predetermined time before the beginning of the sporting events and displaying a final odds for each of the pre-compiled teams; acquiring the plurality of athlete statistics from the provider for each of the plurality of pre-compiled teams during the sporting event; processing the plurality of athlete statistics through a scoring algorithm for assigning an interim ranking to each of the plurality of pre-compiled teams, and displaying the interim ranking to the at least one bettor; acquiring the plurality of athlete statistics from the provider for each of the plurality of pre-compiled teams upon a conclusion of all sporting events; calculating a final ranking for each of the pre-compiled teams; calculating an amount of payout for each of the validated bets in parimutuel style; and paying the bettors.

In one aspect of various exemplary embodiments, a method for parimutuel wagering is provided, the method comprising: a host processor programmed for receiving, compiling, analyzing, creating, and transmitting data relevant to the parimutuel wagering method, wherein the data comprises: a plurality of individual athlete statistics from a provider, a plurality of pre-compiled teams consisting of individual athletes, an initial odds, an interim odds and a final odds for each of the plurality of teams, at least one betting instruction, and a ranking for each of the plurality of teams, wherein the host processor generates the plurality of teams and the initial odds for each of the plurality of teams, combines the plurality of teams and the initial odds for display to at least one bettor, and wherein the host processor opens a betting window and closes the betting window at predetermined times before a beginning of a plurality of sporting events, and wherein the host processor assigns the ranking to each of the plurality of teams; at least one bettor processor operatively connected to the host processor, the at least one bettor processor programmed to receive, manipulate and display the data from the host processor, accept the at least one betting instruction from the at least one bettor, and transmit the at least one betting instruction to the host processor during the betting window, wherein the at least one bettor processor displays the plurality of pre-compiled teams and the initial odds to the at least one bettor and creates the at least one betting instruction by allowing the plurality of bettors to choose a wager type, at least one of the plurality of teams and a bet amount; and a validation processor operatively connected to the host processor, programmed for receiving the at least one betting instruction from the host processor, providing a bet validation of the at least one betting instruction to the host processor, calculating the interim and the final odds, and providing the interim and the final odds to the host processor, wherein the initial odds become the interim odds that change over regular intervals of time for the duration of the betting window, and wherein the interim odds become the final odds upon closing of the betting window, and wherein the validation receives the ranking for each of the plurality of teams from the host processor, and wherein the validation processor calculates an amount of payout for the at least one betting instruction in parimutuel style, and paying the at least one bettor.

In one aspect of various exemplary embodiments, a method for parimutuel wagering is provided, the method comprising: a host processor programmed for receiving data, analyzing data, creating data, transmitting data, and interactively connecting a plurality of bettors for betting on sporting events; a plurality of bettor processors programmed to receive data from the host processor, display data from the host processor, accept at least one betting instruction from the plurality of bettors, and transmit the at least one betting instruction to the host processor; a validation processor programmed for receiving the at least one betting instruction from the host processor, providing a bet validation of the at least one betting instruction to the host processor, calculating the interim and the final odds, and transmitting the interim and the final odds to the host processor, the processors programmed to: acquire individual athlete statistics from a provider; generate a plurality of teams using the individual athlete statistics; generate initial odds for each of the teams; combine the initial odds and the teams for display to the plurality of bettors; display the teams with initial odds for the plurality of bettors to choose at least one of the teams upon which to wager a bet, whereby the initial odds become an interim odds that change over regular intervals of time for the duration of a betting window; display to the plurality of bettors a wager list for selecting a wager type; collect at least one bet from the plurality of bettors and providing a bet validation; close the betting window at a predetermined time before a beginning of the sporting events and displaying a final odds for each of the teams; acquire data from the provider for each of the plurality of teams; process the data through a scoring algorithm for assigning an interim ranking to each of the teams, and displaying the interim ranking to the bettor; calculate a final ranking for each of the teams upon a conclusion of all sporting events associated with the bets that were wagered; calculate an amount of payout for each of the wagers in parimutuel style and paying the bettors.

### BRIEF DESCRIPTION OF THE DRAWINGS

FIG. 1 is a flow diagram depicting an embodiment of the method from the perspective of the host for creating a betting event.

FIG. 2 is a flow diagram depicting an embodiment of the method from the perspective of the bettor.

FIG. 3 is a flow diagram depicting an embodiment of the method from the perspective of the validator.

FIG. 4. is a block diagram depicting an embodiment of the relationship between the host, provider, validator, bettors, and Internet.

FIG. 5. is a table illustrating an embodiment depicting the pre-compiled teams for a team-based sporting event by player ranking.

FIG. 6. is a table illustrating an embodiment depicting the pre-compiled teams for an individual-based sporting event by player ranking.

FIG. 7. is a flow diagram depicting an embodiment of the method from the perspective of the host for determining outcomes of betting events.

FIG. 8. is a flow diagram depicting an embodiment of the method from the perspective of the host for searching upcoming sporting events, creating pre-compiled teams, and creating and transmitting a betting event to bettors.

FIG. 9. depicts a tabular format of the scoring algorithm for a team-based sporting event.

FIG. 10. depicts a tabular format of two different scoring algorithms for individual-based sporting events.

FIG. 11. illustrates an embodiment of a display for which a bettor can choose an upcoming betting event.

FIG. 12. illustrates an embodiment of a display for which a bettor can choose a team upon which to place a wager.

FIGS. 13a-d. illustrate an embodiment of a host user interface.

### DETAILED DESCRIPTION

In the following detailed descriptions of various embodiments, reference is made to the accompanying drawings that form a part hereof, and in which is shown, by way of illustration, specific embodiments that may be practiced. It is to be understood that other embodiments may be utilized and structural changes may be made without departing from the scope of the present disclosure.

Before describing the method, several terms must be defined to enable the reader correct interpretation of the meaning behind each concept.

The term ‘sporting event’ should be understood as a generic term that describes myriad sporting events, and in particular, the timeframe over which they are played. For example, a sporting event in football consists of one week of football during the regular season, such as Week 1, and usually begins on a Tuesday and concludes on the following Monday. However, a sporting event in baseball is different because it usually consists of a series of three or more games played between two different teams during a week of the regular season. Furthermore, an event in golf is different still because a tournament usually begins on a Thursday and usually concludes on a Sunday, except not all golfers ranked by the Stats Provider play in the same weekend tournament. Hence, there may be several tournaments that must complete before bettors can be paid because the ranked players from each of the pre-compiled teams must be given a chance to perform or gain points. The aforementioned sports are provided as examples only to describe that all sporting events are held over varying windows of time, and should not to be construed to be inclusive of all sporting events or all sporting event durations.

### Definitions

The following definitions are provided to enable the readers' understanding of this disclosure:

Betting Window: set by the host, a period of time during which bets may be placed on a pre-compiled team.

Initial Ranking: a rank assigned to a pre-compiled team before the betting window opens.

Interim Ranking: a rank assigned to a pre-compiled team while the betting window is open.

Final Ranking: a rank assigned to a pre-compiled team after the betting window closes.

Initial Odds: before the betting window is open, an amount of a bet payout (expressed as a ratio) that a pre-compiled team will return to the bettor.

Interim Odds: while the betting window is open, an amount of a bet payout (expressed as a ratio) that a pre-compiled team will return to the bettor.

Final Odds: after the betting window is closed, an amount of a bet payout (expressed as a ratio) that a pre-compiled team will return to the bettor.

Wager: a gambling scenario upon which a bettor can place money; ex. win, place, or show.

Bet: money given to the host in exchange for a chance to win more money.

Betting Instruction: bettor communication to describe the event, the pre-compiled team or teams that will finish in ranked order, and the amount of money to bet.

Bet Validation: a unique code given to the bettor in exchange for a placing a bet that traces to a particular betting instruction.

Parimutuel: a form of betting in which all bets of a particular type are placed together in a pool, less the host's commission.

Pre-compiled team: a fictional group of human athletes formed by the host in advance of a sporting event.

Host: administrator and organizer of the parimutuel method.

Bettor: a person that interacts with the host to engage in the parimutuel method.

Validator: an entity that handles monetary transactions.

Host processor: a computer that enables the host to electronically administrate and organize the parimutuel method.

Bettor processor: a computer that enables the bettor to electronically interact with the host to engage in the parimutuel method.

Validation processor: a computer that enables the validator to electronically interact with the host and bettor.

Statistics Provider: an entity that tracks and publishes statistics for athletes

Total Pool—amount of money bet by all the bettors on a betting event

Team Pool—the amount of money bet on one of the pre-compiled teams in a betting event

Take Percent—the percentage of money deducted from the total pool to cover profit, expenses, and taxes.

### The Method

The invention is a parimutuel sports betting method based on determinate human sporting events, where the teams from which bettors may choose are comprised of the top ranked players or athletes at that position. The method may be computerized and adapted for use and play over electronic networks, such as the Internet. Alternatively, the computerized method may also be used and played over an intranet or other private network. Also, the method may be played at a physical location such as a convenience store (similar to the way the lottery games are played) or at a casino, whereby the host issues the bettor a paper ticket.

The method combines data from a ‘sports statistics provider’ (hereinafter ‘provider’) and a scoring algorithm to pre-compile teams for future sporting events or contests. For team-based sports such as football, basketball, baseball, soccer, e-Sports and the like, athletes are assigned to teams based on several factors, comprising their player position (quarterback, wide receiver, center, point guard, and so forth), year-to-date scoring average as determined by the aforementioned scoring matrix and algorithm, and availability for the upcoming contest. If no data has yet been acquired from an athlete, such as a rookie or the beginning of the season, then the provider may provide a ranking. For individual-based sports such as tennis, golf, auto racing and so forth, athletes are assigned to teams based on their year-to-date scoring average as determined by the scoring matrix and algorithm, and availability for the upcoming event.

Using the provider's data as a filter, only players deemed active at the time of event creation are available to be added to a pre-compiled team for that particular contest. Players injured, suspended, or otherwise deemed inactive at the time of contest creation are excluded from the available player pool for that particular contest. Depending on the type of betting event, players that are injured, suspended, or otherwise become inactive during the contest may be replaced by the host with their backup player. For example, if the primary quarterback is hurt during the game and, due to their injury can no longer compete, then the secondary quarterback can substitute into the game to continue earning points that the primary quarterback would otherwise have scored.

For team sports, active players with the highest year-to-date scoring average at their position are added to a first team, or Team 1. Active players with the next-highest year-to-date scoring average at their position are added to a second team, or Team 2. This methodology continues until all teams in a contest or event have athletes assigned to each position. For example, let's assume there's an upcoming professional football contest and that the active quarterbacks with the highest year-to-date scoring averages are Tom Brady (30.0), Cam Newton (27.0), Alex Smith (24.0), and Matthew Stafford (21.0). For this upcoming contest, Tom Brady, as the highest ranked quarterback, would be assigned to Team 1, Cam Newton to Team 2, Alex Smith to Team 3, and Matthew Stafford to Team 4. The aforementioned example is meant to provide only a limited sample of quarterbacks because there are 32 professional football teams with at least 2 quarterbacks per team, and the rankings change with frequent periodicity.

In another embodiment of the team sports method, the professional teams themselves may be ranked using the projected scoring or the scoring algorithm for each of the players on that team. Hence, a betting event may be created for the bettor to choose an entire professional team or a series of professional teams based on their ranking.

For individual sports, active players with the highest year-to-date scoring averages are added to Team 1 until the team is full. Active players with the next-highest year-to-date scoring averages are added to Team 2 until the team is full, and this methodology continues until all Teams in a contest are full. In this context, the term ‘full’ is understood to mean at least two athletes as assigned to a team. However, there may be 3, 4, or more assigned. As an example, let's assume there's an upcoming professional golf contest where each team contains 4 golfers. In this example, the golfers with the highest year-to-date scoring averages are Tiger Woods (38.0), Jason Day (36.5), Justin Rose (35.0), Rory McIlroy (33.5), Jordan Spieth (32.0), Dustin Johnson (30.5), Brooks Koepka (29.0), and Justin Thomas (27.5). Since Woods, Day, Rose, and McIlroy are the highest ranked players, then Team 1 would consist of Woods, Day, Rose, and McIlroy. Team 2 would consist of Spieth, Johnson, Koepka, and Thomas. The aforementioned example is not meant to be construed as a typical scenario because there are many other professional golfers with rankings changing with frequent periodicity.

If the method creates a contest for the first week or event of the professional sports league's season (Week 1 of the NFL Season, Opening Night of the NBA Season, Daytona 500 for NASCAR, etc.), the method may utilize the provider's projected stats for that contest to generate projected athlete rankings. The projections are then used to pre-compile teams in lieu of year-to-date averages. However, the other aspects of the process remain identical. For example, if Tom Brady has the highest projected points total for Week 1 of the NFL season, he will be the quarterback for Team 1 in Week 1's contest. If Cam Newton has the second-highest projection for Week 1, then he will be the quarterback for Team 2 in Week 1's contest.

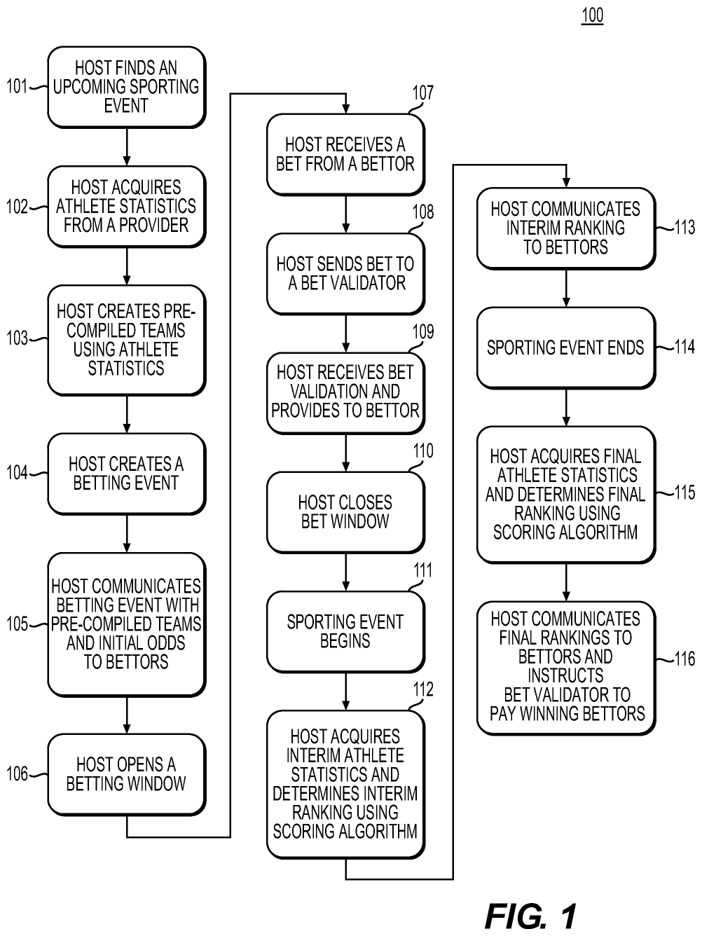

Turning now to FIG. 1, an embodiment of the method is illustrated as a flow diagram 100, where the host pre-compiles teams for use in a betting event and the host makes that event available to bettors, and whereby the host manages all aspects of the event and acquires data from a statistics provider for determining winners of betting events. In the first step 101, the host computer may comprise a host processor which may search for, and may find, one or more upcoming sporting events that may be less than a period of time in the future, such as one month. The amount of time a sporting event will be played in the future is an adjustable parameter because it can decrease or increase the total number of betting events available to the bettor at any given time. Next, in step 102, the host processor acquires athlete statistics from the provider. The host processor may acquire the statistics in different formats which may or may not require further processing to convert into a player ranking. Then, in step 3, the host will create the pre-compiled teams using the athlete statistics acquired in step 2 and rank them from 1 to n. Naturally, these teams are based on the upcoming event found during step 101 and so may be team-based or individual-based teams. Once the teams are created and ranked, then the host processor can create a betting event as in step 104. The host processor creates data at this point in the method, such as initial odds. Initial odds may be determined and applied using a simple 1:1, 2:1, 3:1, etc. format, or may be computed using a more rigorous approach that uses factors such as win streaks, home or away game, forecasted weather, and so forth. In step 105, the host processor will then communicate the betting event with the pre-compiled teams and initial odds to the bettors. Communication of the betting event does not necessarily open the betting window, thus the betting window is opened by the host at a predetermined time in step 106. An amount of time that the window is open may be variable by the host. For example, the betting window may open 2 days before the start of the event. During the betting window, one or more bettors may place a bet, which may then be received by the host processor according to step 107. Then, in step 108, the host processor sends the bet to the validation processor (also referred to as validator processor) which may serialize the transaction, may verify the authenticity of the bet, and may receive funds for the bet. Next in step 109, the validator processor provides the host processor and bettor processor with a bet validation. Then, in step 110, the host processor will close the bet window after a predetermined amount of time or at a period of time prior to the start of the sporting event. One minute is a typical length of time before the start of the event but is a variable that may be set by the host. Also, when the betting window closes, the interim odds become final odds. Final odds can be written as an expression, which may be as follows:

Final Odds=((total pool)*(take percent)−(amount bet on a pre-compiled team))/(team pool)

Moving on to step 111, the sporting event begins and then the host processor acquires interim athlete statistics and determines interim rankings using the scoring algorithm per step 112. These interim rankings for the pre-compiled teams are communicated to the bettor processors for the duration of the sporting event in step 113, which will ultimately end as shown in step 114. Step 115 of the method is for the host processor to acquire the final athlete statistics and determine the final ranking of the pre-compiled teams. Finally, in step 116, the host processor communicates the final rankings of the pre-compiled teams to the bettor processors and instructs the validator processor to pay the winning bettors.

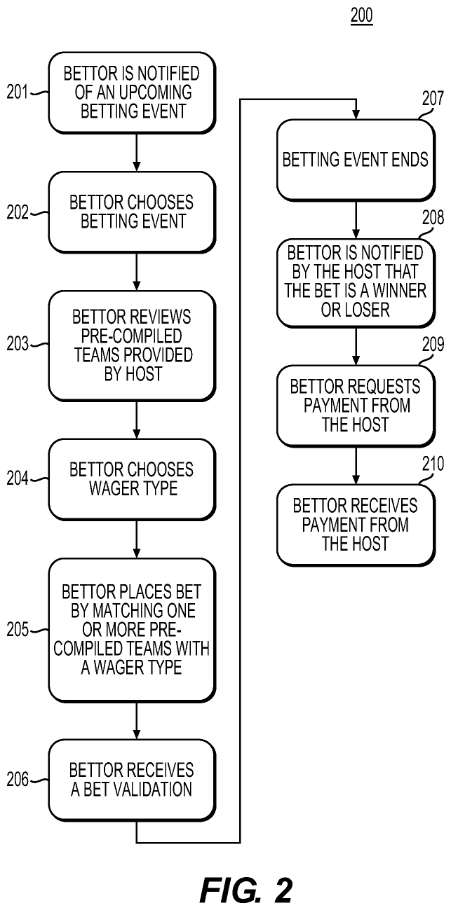

In FIG. 2, an embodiment of the method is illustrated as a flow diagram 200, illustrating how the bettor may follow the method in order to choose a team, choose a wager, and place a bet. In the first step 201, the bettor is notified of an upcoming betting event. Notifications may be pushed to bettors via traditional advertisements such as those broadcast on television, billboards, newspapers, flyers, or the like. Notifications may also be electronically pushed using the Internet such as emails, mobile device notifications, texts, and so forth. Upon receive the notification, the bettor chooses the betting event according to step 202 upon which the bettor would like to place a bet. Then in step 203, the bettor reviews the pre-compiled teams provided by the host. Next in step 204, the bettor chooses the wager type such as win/place/show, exacta, trifecta, and so forth. Then in step 205, the bettor places a bet by matching one or more teams with the particular wager type. Next in step 206, the bettor receives a bet validation. The betting event ends according to step 207, normally caused by the beginning of the sporting event. Then, the bettor is notified by the host that the bet is a winner or loser per step 208. Again, notification may be accomplished in various ways such as those aforementioned traditional or electronic means. In an embodiment that mimics the physical scenario of a horsetrack, the bettor may present the validated bet ticket to a cashier or machine to verify the winning bet. Next, in step 209, the bettor requests payment from the host which may take the form of a verbal or written demand, or through a button press or screen-click in a mobile device. Finally, in step 210, the bettor receives payment from the host. Payment means may take the form of cash, check, credit, electronic payment, or other means known to those skilled in the art.

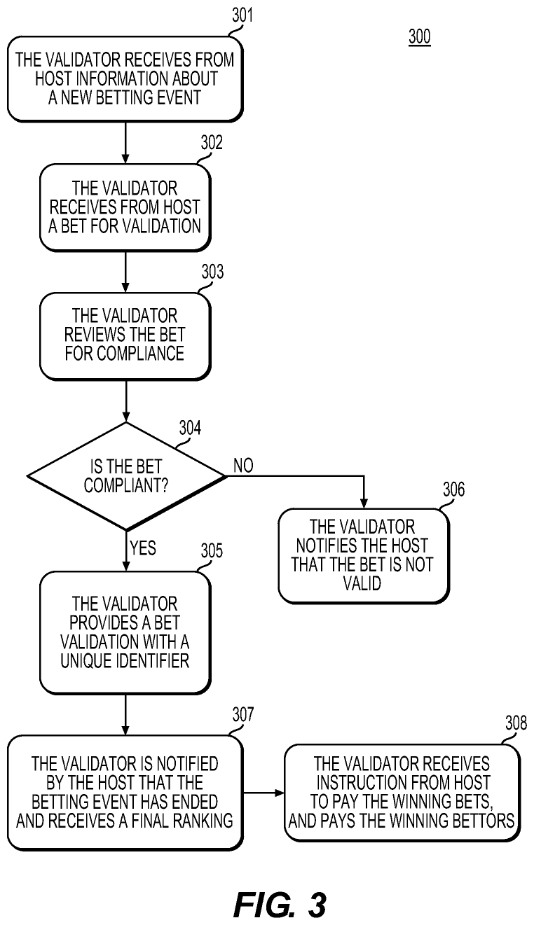

In FIG. 3, an embodiment of the method is illustrated as a flow diagram 300, which shows how the validator may follow the method in order to receive a bet, validate the bet, and provide bet validation back to the bettor. In the first step 301, the validator receives information about an new betting event from the host. In the next step 302, the validator receives a bet for validation from the host, which is then reviewed for compliance by the validator in step 303. The validator, then has two options according to step 304; determine the bet is compliant or determine the bet is not compliant. If the bet is not compliant, then the validator notifies the host that the bet is not valid according to step 306. If the bet is compliant, then the validator provides a bet validation with a unique alphanumeric code, number or identifier per step 305. Next, in step 307, the validator is notified by the host that the betting event has ended and receives a final ranking. Finally, in step 308, the validator receives instruction from the host to pay the winning bets and pays the winning bettors.

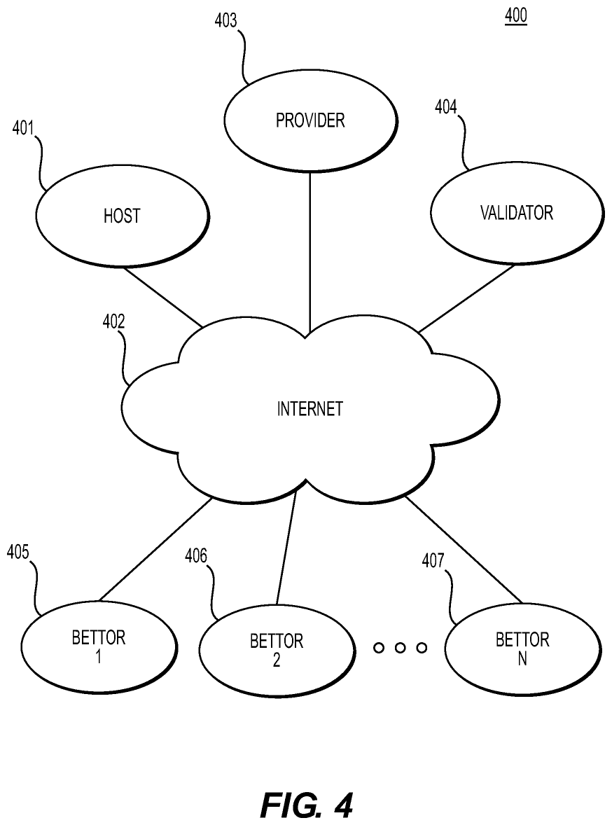

Now in FIG. 4, block diagram 400 illustrates an embodiment of the relationship between the host 401, provider 403, validator 404 , bettors 405 through 407, and Internet 402 for accomplishing a computerized method. The host 401 may interact with the provider 403, the validator 404, and bettors 405,406,407 through the Internet 402, where interaction may be achieved through a wired or wireless connection such as those known by those skilled in the art. Interaction may involve transmitting and/or receiving data such as sports athlete statistics, bets, odds, payments, unique transaction identifiers, bettor identifications, and so forth. Naturally, to communicate over the Internet, one would need to use computer processors in order to digitize, transmit, and receive data. In this case, the host 401 uses a host processor to communicate with a validator processor used by the validator 404. In this same scenario, each of the 1-n bettors 405 through 407 use bettor processors running on a mobile device, a standalone terminal, a server, and so forth in order to communicate with the host processor and validator processor through the Internet 402.

Another embodiment of the relationship of the method participants can be envisioned simply by substituting the Internet 402 by a physical location such as convenience store cashier, racetrack cashier, casino cashier, or the like. In this manner, the method may be non-computerized and human cashiers at these physical locations may collect payment for bets made by the bettors 405 through 407 and issue a validated bet to the bettors 405 through 407 in the form of a paper receipt. The host 401 and validator 404 may communicate with the various cashiers through an electronic network or telephonically.

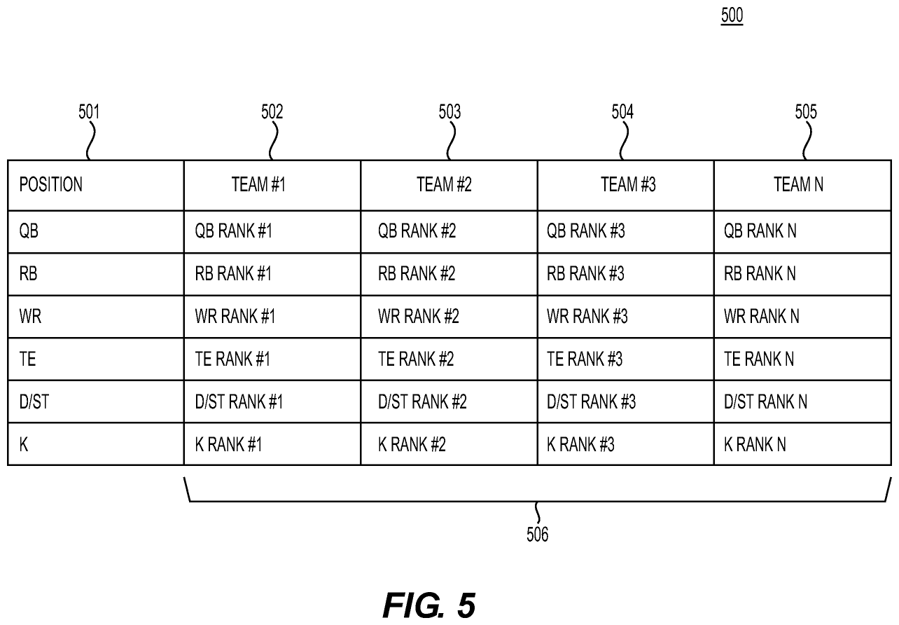

FIG. 5 depicts Team #1 through Team #N as pre-compiled teams 506 from a teams-based sport organization in the format of a table 500. The teams 506 are represented by columns 502 through 505, and the positions for each of the athletes on a pre-compiled team are represented by column 501. Team #1 has the top-ranked player for each of the positions, Team #2 has the second-ranked player for each of the positions, and so forth. In this way, all of the athletes within an organization such as the National Football League (NFL) may be placed onto a pre-compiled team 506 regardless of the number of teams in the NFL. Said another way, there may be more pre-compiled teams 506 upon which to place a wager than there are teams in the NFL because each position has at least two athletes per team to fill that position.

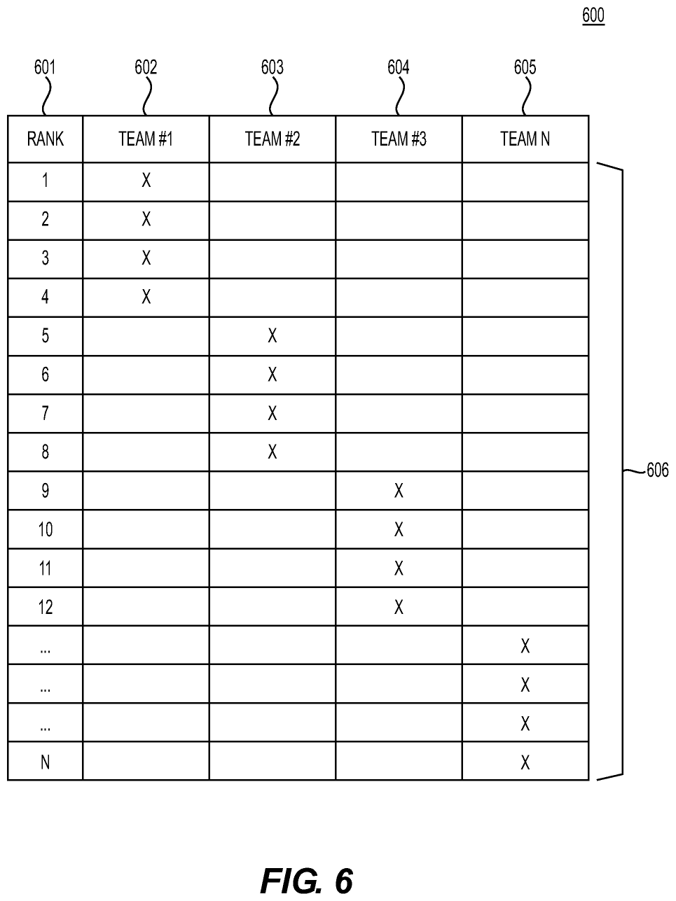

FIG. 6 depicts Team #1 through Team #N as pre-compiled teams 602 through 605 from an individual-based sport organization in the format of a table 600. The pre-compiled teams are represented by columns 602 through 605 and the athlete rankings are represented by column 601. The rows 606. The “X” in table 600 denotes an athlete assigned to that team. For example, in column 602 Team #1 has four athletes assigned to it of rank 1 through 4. The number of athletes assigned to a particular team is a variable parameter that may be increased or decreased by the host when forming a pre-selected team.

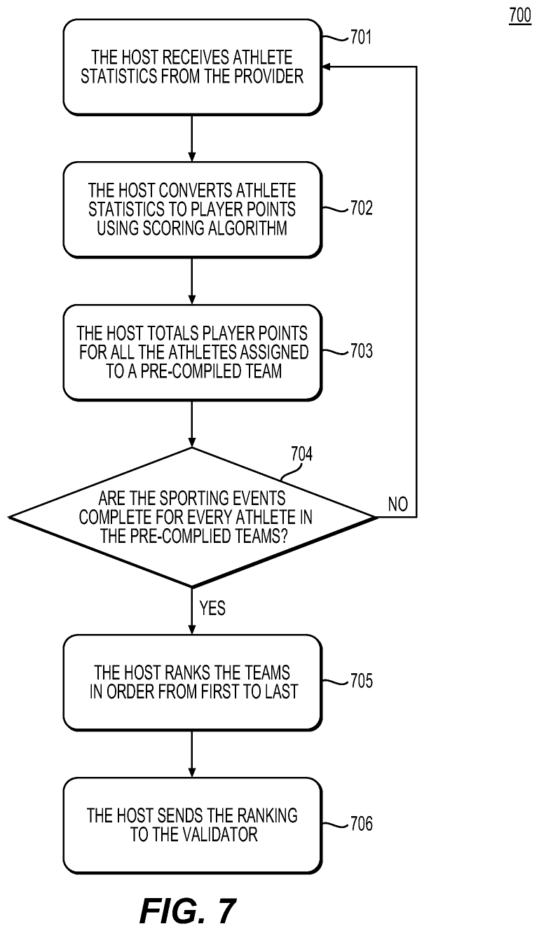

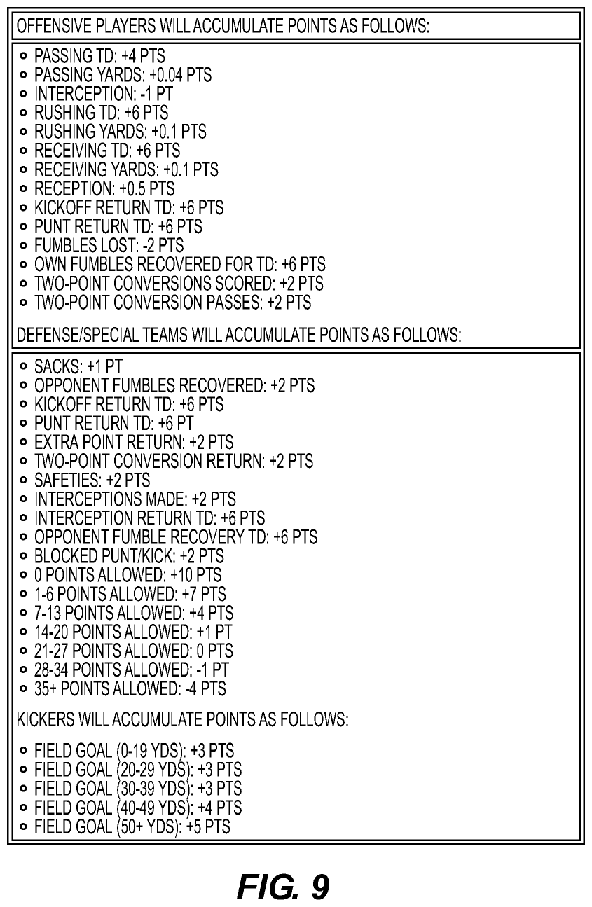

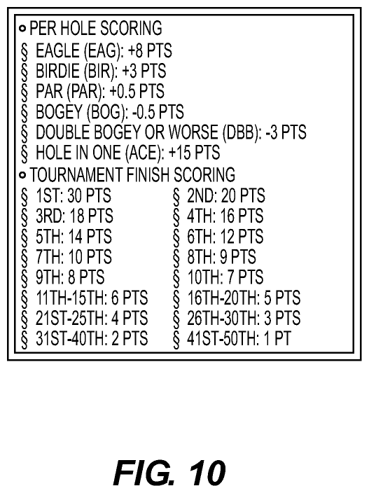

In FIG. 7, an embodiment of the method is illustrated as a flow diagram 700, which shows how the host may follow the method to determine betting event outcomes. First, the host receives athlete statistics from the provider in step 701. Next, in step 702, the host converts the athlete statistics to player points using a scoring algorithm, such as those described in the foregoing description and shown in FIGS. 9-10. Once converted through the algorithm, the host totals the player points for all the athletes assigned to a pre-compiled team according to step 703. Step 704 is a deterministic outcome for which the host will take a different action according to answering whether or not the sporting events a complete for every athlete in the pre-compiled teams. If yes, then the host can move to step 705. If no, then the host must go back to step 701 for gathering more athlete statistics from the provider. If all sporting events are complete for every athlete in the pre-compiled teams, then the host ranks the teams in order from first to last in step 705. Finally, the host sends the ranking to the validator in step 706 in order to determine the payouts to each of the bettors.

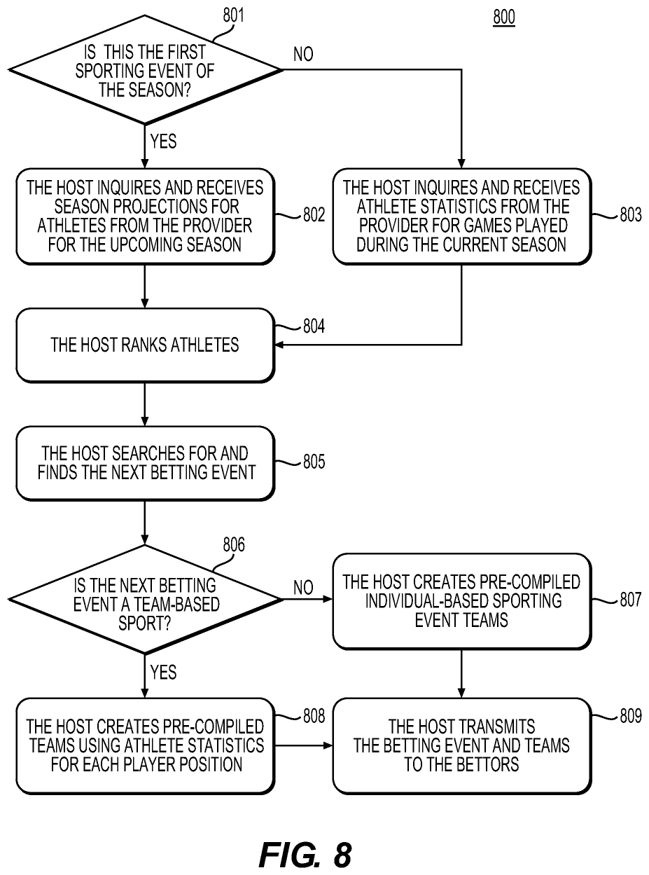

In FIG. 8, an embodiment of the method is illustrated as a flow diagram 800, which shows how the host may follow the method to create a betting event. Step 801 is a deterministic outcome for which the host will take a different action according to answering whether or not the sporting event is the first of the season. If the answer is yes, then the host can proceed to step 802 which requires the host to inquire and receive from the provider season projections for athletes for the upcoming season. If the answer is no, then the host must proceed to step 803 which is to inquire and receive athlete statistics from the provider for games played during the current season. Once all player projections or statistics are received, then the host can rank the athletes from first to last in step 804. In step 805, the host must search for and find the next betting event (sporting event upon which to place a bet). Step 806 is another deterministic outcome where the host must determine whether the next betting event is a team-based sport. If yes, then the host creates pre-compiled teams using athlete statistics for each player position in step 808. If the answer is no, then the host creates pre-compiled individual-based sporting event teams in step 807. Once the pre-compiled teams are created, then the host transmits the betting event and teams to the bettors in step 809.

FIG. 9 depicts a tabular format of a scoring algorithm embodiment for a team-based sporting event. This particular algorithm embodiment translates football athlete statistics into points. The total number of points scored by all athletes on a pre-compiled team determines the final rank of the team in the betting event. The higher the points scored, the better the final ranking. For example, if the total points scored by all the athletes on Team #1 is 100, and the total points scored by all the athletes on Team #2 is 110, then Team #2 is ranked better than Team #1.

FIG. 10 depicts scoring algorithm embodiments in a tabular format for an individual-based sporting event. The algorithm shown is for translating golf statistics into points. There are two types of scoring that can be used either individually or in combination. The first type is per-hole scoring, and the second type is tournament finish scoring. Following the per-hole scoring type algorithm to illustrate functionality of the algorithm, if a golfer athlete makes all pars during a weekend tournament (72 holes total), then that golfer would accumulate 36 points because 72×0.5 pts=36. Yet, using the tournament finish scoring algorithm, if that same golfer athlete places 10^{th} in the tournament, then that golfer would accumulate 7 points. Either type could be used singularly or both types could be jointly applied for scoring. To finish the example, combining the two algorithm types would result in that same golfer accumulating a total of 43 points (36+7).

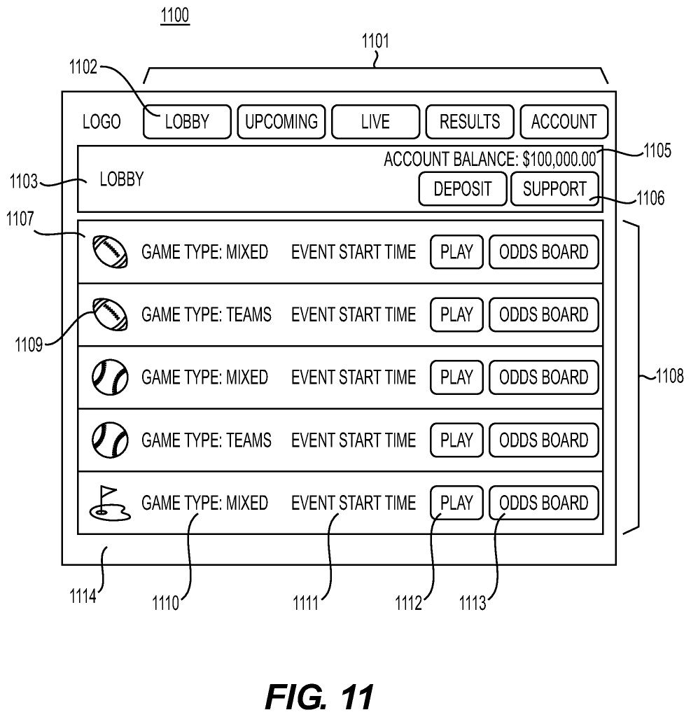

FIG. 11 illustrates an embodiment of a display 1100 that a bettor may encounter when playing the pariwager game on a personal computer or mobile device. FIG. 11 may be referred to hereinafter as the “home screen”, though the inventor envisions many different forms of an embodiment display 1100. Various information and menu options may be presented to the bettor. In the viewable portion 1114 of the display 1100, and along the top of the display, menu buttons 1101 may be available for selection by the bettor to access various features of the pariwager game. As an example, selecting the “lobby” menu button 1102 may create a list of all betting events 1108 that are active or still yet to be activated. Located above the list of betting events 1108, a space 1103 containing the currently selected menu option and bettor information may exist. The bettor information may comprise an account balance 1105, a “deposit” button to add funds to an account balance, a button to contact host support 1106, the bettor username (not shown), and so forth. The betting events 1108 may be sorted via the bettor by row or by column. Individual betting events, such as row 1107, may contain relevant information about a singular betting event, while columns may contain the sporting event type 1109, “game type” 1110, “event start time” 1111, “odds” 1113, and so forth. The sporting event type 1109 may have a symbol to allow the bettor to more easily and quickly identify the event. The game type 1110 comprises many different variations of pre-compiled teams for the bettor to choose such as mixed, starters, and teams. To enhance the user experience, the rows and columns may be scrollable with a swipe, button, mouse-click, hand gesture, or other means known to those skilled in the art. “Event start time” 1111 may be the start time of the sporting event, a countdown timer until game start, a countdown timer until game finishes, and so forth. And the “odds board” button 1113 may show the initial odds, interim odds, or final odds depending on whether the betting event window has opened or closed. Initial odds may be displayed prior to the betting window opening. Interim odds may be displayed during the pendency of the betting window. Final odds may be displayed after the betting window closes. Initial and final odds are typically static values, whereas interim odds are typically dynamic values which change at regular intervals of time while the betting window is open to inform bettors which teams are receiving the most or least bets. Interim odds may be refreshed at a rate that corresponds to the length of time the betting window is open, or may be a fixed period of time such as 5 seconds or 1 minute. The amount of time may also be a host or a bettor adjustable setting for improving the user experience. The “Odds board” button 1113 may also be a selectable button to open a new screen, menu, website, and so forth. The “Play” button 1112 may be selectable by the bettor to initiate placing a bet. Prior to opening the betting window, the Play button 1112 may be invisible, ‘greyed out’ or otherwise unselectable to prevent the bettor from accidentally making an incorrect selection. During the pendency of the betting window, the Play button 1112 may become selectable to permit the bettor to place a bet.

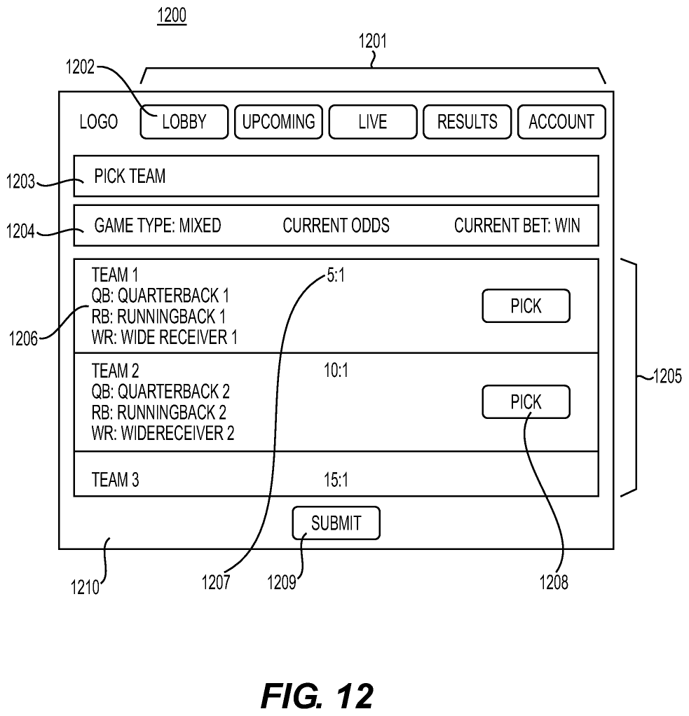

FIG. 12 illustrates another embodiment of a display 1200 that a bettor may encounter when playing the pariwager game on a personal computer or mobile device. As in FIG. 11, various information and menu options may be presented to the bettor. In this illustration, the “Play” button from the first row of the list of betting events 1108 was selected by the bettor. In the viewable portion 1210 of the display 1200, and along the top of the display, menu buttons 1201 may remain available for selection by the bettor to access various features of the pariwager game. For example, selecting the “Lobby” menu button 1202 may bring the bettor back to the home screen. In one of many alternative embodiments, the buttons may be replaced with a “Back” button (not shown) to bring the bettor to a previous display. Located above the list of teams 1205 upon which to place a bet, spaces 1203 and 1204 provide information to the bettor such as an instruction “Pick Team”, the type of game under review, the odds 1207, the current bet and so forth. The first row in the list of teams 1205 may be the team with the highest ranked players 1206. This row may contain the team composition such as player names or statistics, odds of the team winning, a “Pick” button 1208 to choose the team upon which to place a bet, and the like. Other rows within the list of teams 1205 may contain the remainder of teams upon which to place a bet. Columns within the list of teams 1205 may contain wager type, “undo pick” button, bet amount, and the like. As with the previous embodiment display, the rows and columns may be scrollable with a swipe, button, mouse-click, hand gesture, or other means known to those skilled in the art. Once the bettor has decided upon the team to place a bet from the list of teams 1205, then the bettor may select the “Pick” button 1208. The term “Pick” may be replaced by “Choose”, “Select”, “My Winner”, and so forth. Then, when the bettor is satisfied with their choices, then the bettor may choose the “Submit” button 1209 in order to finalize their bet and proceed to receipt of a bet validation from the validator.

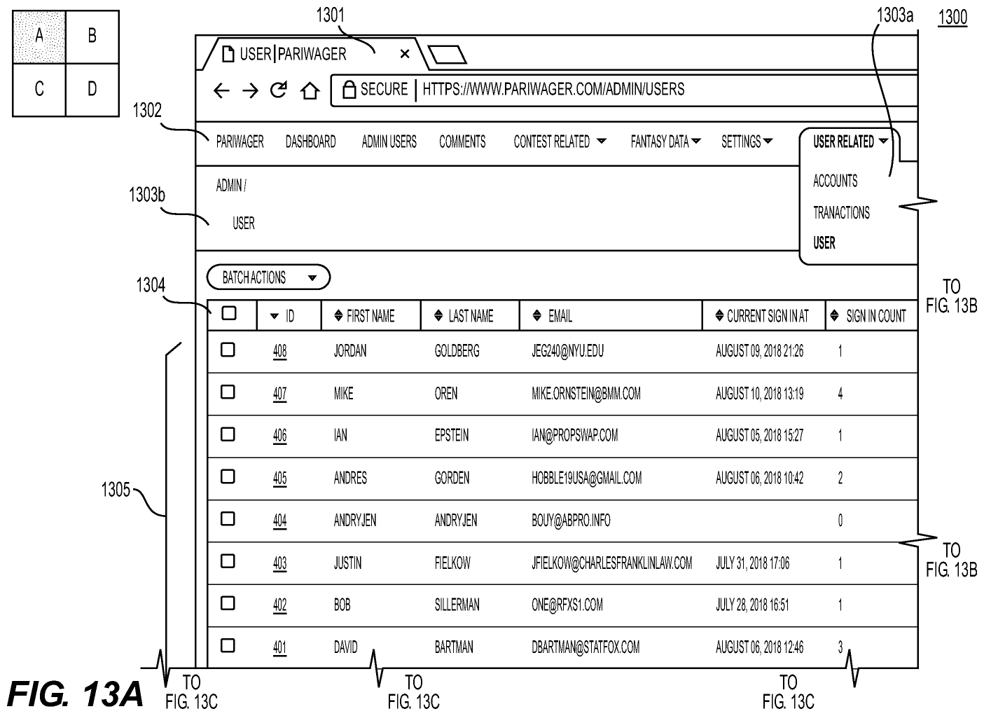

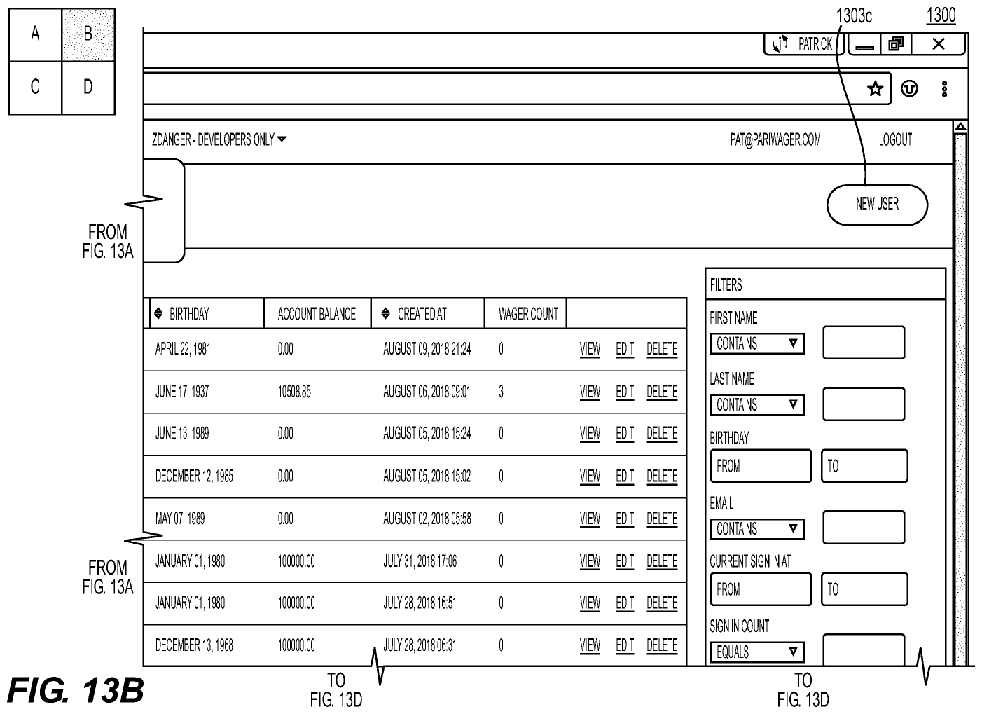

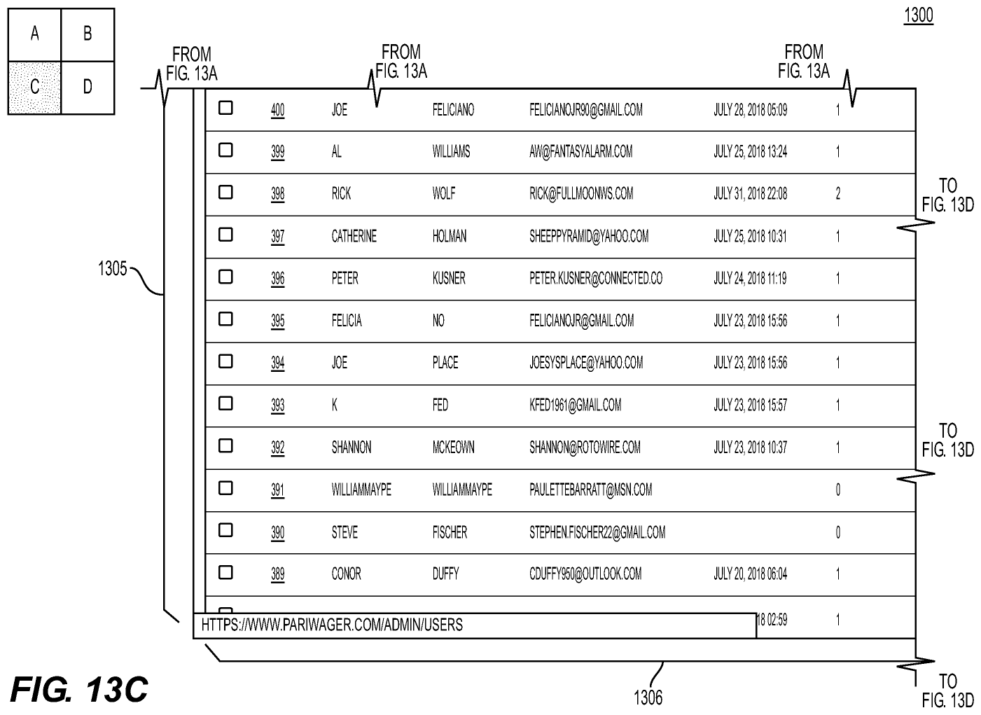

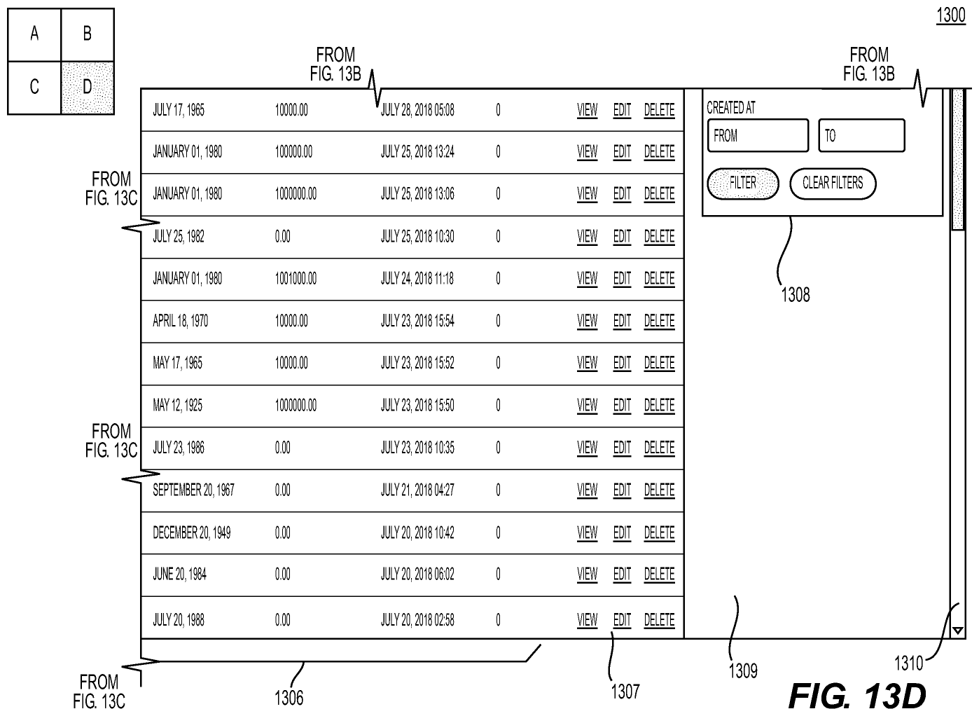

FIGS. 13A-D illustrates an embodiment of a host user interface 1300. In FIG. 13A, a webpage 1301 is shown, though other options are considered such as a standalone application. The menu bar 1302 may contain menus 1303a, functions, and commands upon which the host may use to take a multitude of actions such as restore or remove user permissions, send messages to users, search user betting history, find user information, and so forth. Once selected by the host, a status bar 1303b may display information about the current function or provide additional functions such as the “New User” button 1303c, which may add or create a new bettor profile. The main portion of the host user interface 1300 may comprise rows 1305 and columns 1306 to display the database of information in an organizable fashion for the users/bettors, teams, athlete statistics, bets, game types, and so forth. Given the amount of information in the database, the data may have a scrollbar 1310 and/or pagination feature (not shown) to navigate through the individual rows 1305. Each of the columns 1306 may have buttons 1304 to sort, select, and categorize the database of information. The columns 1306 may be configurable by the host to enhance the user experience by providing a multitude of preferential options to display the database of information. Each of the rows may also be independently configurable using the view/edit/delete hyperlinks 1307, or be filterable using the filter window 1308. There may exist a sandbox 1309 to the right of the rows 1305 and columns 1306 for future expansion of additional functions.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A parimutuel wagering method for betting on sporting events using a plurality of pre-compiled teams, comprising:
acquiring a plurality of athlete statistics from a provider before a beginning of a sporting event;
generating a plurality of pre-compiled teams using the plurality of athlete statistics;
generating an initial odds for each of the pre-compiled teams;
combining the initial odds and the pre-compiled teams for display to at least one bettor;
displaying the pre-compiled teams with the initial odds for the at least one bettor to choose at least one of the teams upon which to wager a bet, whereby the initial odds becomes an interim odds that changes over regular intervals of time for the duration of a betting window;
displaying to the at least one bettor a wager list for selecting a wager type;
collecting at least one bet from the at least one bettor and providing a bet validation;
closing the betting window at a predetermined time before the beginning of the sporting events and displaying a final odds for each of the pre-compiled teams;
acquiring the plurality of athlete statistics from the provider for each of the plurality of pre-compiled teams during the sporting event;
processing the plurality of athlete statistics through a scoring algorithm for assigning an interim ranking to each of the plurality of pre-compiled teams, and displaying the interim ranking to the at least one bettor;
acquiring the plurality of athlete statistics from the provider for each of the plurality of pre-compiled teams upon a conclusion of all sporting events;
calculating a final ranking for each of the pre-compiled teams;
calculating an amount of payout for each of the validated bets in parimutuel style; and
paying the bettors.

2. The method of claim 1, wherein the pre-compiled teams are formed from a plurality of athletes competing in team-based sporting events.

3. The method of claim 2, wherein a highest ranked pre-compiled team comprises the highest ranked athletes at each position, as determined by the provider.

4. The method of claim 2, wherein a second highest ranked pre-compiled team comprises a second highest ranked athlete at each position, as determined by the provider.

5. The method of claim 2, wherein a third highest ranked pre-compiled team comprises a third highest ranked athlete at each position, as determined by the provider.

6. The method of claim 1, wherein the pre-compiled teams are formed from athletes competing in individual-based sporting events.

7. The method of claim 6, wherein a highest ranked pre-compiled team comprises at least two of the highest ranked athletes, as determined by the provider.

8. The method of claim 6, wherein a second highest ranked pre-compiled team comprises at least two of a next group of highest ranked athletes, as determined by the provider.

9. The method of claim 6, wherein a third highest ranked pre-compiled team comprises at least two of a next group of highest ranked athletes, as determined by the provider.

10. The method of claim 1, wherein the at least one bettor is a plurality of bettors.

11. The method of claim 1, wherein the plurality of pre-compiled teams are formed at least twenty-four hours before the beginning of the sporting event.

12. The method of claim 1, wherein the athlete is a professional.

13. The method of claim 1, wherein the scoring algorithm remains constant for the entire duration of the sporting event.

14. The method of claim 1, wherein the host processor, the at least one bettor processor, and the validation processor interact by means of the Internet.

15. The method of claim 1, wherein each of the bettor processors are connected to the host processor by means of a wireless Internet connection.

16. The method of claim 1, wherein the host processor is connected to the validation processor by means of a wireless Internet connection.

17. The method of claim 1, wherein the at least one bettor pays for the at least one bet using an electronic payment method.

18. The method of claim 1, wherein the wager type comprises horserace-style wagers.

19. The method of claim 1, wherein the final odds are calculated by an odds algorithm being
Final Odds=((total pool of bets)*(take percent)−(amount bet on a pre-compiled team))/(pre-compiled team pool of bets)

20. The method of claim 1, wherein the at least one bettor receives payment on a winning bet via an electronic payment method.

21. The method of claim 1, wherein the final ranking is determined by the scoring algorithm on the host processor and transmits the final ranking to the validation processor.

22. The method of claim 1, wherein the bet validation is identified with a unique number.

23. A computerized parimutuel wagering method for betting on sporting events using pre-compiled teams, comprising:
a host processor programmed for receiving, compiling, analyzing, creating, and transmitting data relevant to the parimutuel wagering method, wherein the data comprises:
a plurality of individual athlete statistics from a provider,
a plurality of pre-compiled teams consisting of individual athletes,
an initial odds, an interim odds and a final odds for each of the plurality of teams,
at least one betting instruction, and
a ranking for each of the plurality of teams,
wherein the host processor generates the plurality of teams and the initial odds for each of the plurality of teams, combines the plurality of teams and the initial odds for display to at least one bettor, and wherein the host processor opens a betting window and closes the betting window at predetermined times before a beginning of a plurality of sporting events, and wherein the host processor assigns the ranking to each of the plurality of teams;
at least one bettor processor operatively connected to the host processor, the at least one bettor processor programmed to receive, manipulate and display the data from the host processor, accept the at least one betting instruction from the at least one bettor, and transmit the at least one betting instruction to the host processor during the betting window, wherein the at least one bettor processor displays the plurality of pre-compiled teams and the initial odds to the at least one bettor and creates the at least one betting instruction by allowing the plurality of bettors to choose a wager type, at least one of the plurality of teams and a bet amount; and
a validation processor operatively connected to the host processor, programmed for receiving the at least one betting instruction from the host processor, providing a bet validation of the at least one betting instruction to the host processor, calculating the interim and the final odds, and providing the interim and the final odds to the host processor, wherein the initial odds become the interim odds that change over regular intervals of time for the duration of the betting window, and wherein the interim odds become the final odds upon closing of the betting window, and wherein the validation receives the ranking for each of the plurality of teams from the host processor, and wherein the validation processor calculates an amount of payout for the at least one betting instruction in parimutuel style, and paying the at least one bettor.

24. The computerized method of claim 23, wherein the pre-compiled teams are formed from athletes competing in team-based sporting events.

25. The computerized method of claim 24, wherein the team-based sporting events comprise baseball, football, basketball, hockey, soccer and e-Sports.

26. The computerized method of claim 23, wherein the pre-compiled teams are formed from athletes competing in individual-based sporting events.

27. The computerized method of claim 26, wherein the individual-based sporting events comprise golf, automobile racing, tennis, and e-Sports.

28. The computerized method of claim 23, wherein the athlete is a professional.

29. The computerized method of claim 23, wherein the host processor assigns the ranking to each of the plurality of teams using a scoring algorithm.

30. The computerized method of claim 29, wherein the scoring algorithm remains constant for the entire duration of the sporting event.

31. The computerized method of claim 23, wherein the host processor, the at least one bettor processor, and the validation processor interact by means of the Internet.

32. The computerized method of claim 23, wherein the at least one bettor processor is connected to the host processor by means of a wireless Internet connection.

33. The computerized method of claim 23, wherein the host processor is connected to the validation processor by means of a wireless Internet connection.

34. The computerized method of claim 23, wherein the wager type comprises horserace-style wagers.

35. The computerized method of claim 23, wherein each of the at least one bettor pays the bet amount via an electronic payment method.

36. The computerized method of claim 23, wherein the final odds are calculated by an odds algorithm being
Final Odds=((total pool)*(take percent)−(amount bet on a pre-compiled team))/(team pool)

37. The computerized method of claim 23, wherein the at least one bettor is paid via an electronic payment method.

38. The computerized method of claim 23, wherein the ranking is determined by the scoring algorithm on the host processor at the conclusion of the sporting event.

39. The computerized method of claim 38, wherein the ranking is transmitted to the validation processor for calculating the amount of payout.

40. The computerized method of claim 23, wherein the bet validation is identified with a unique number.

41. The computerized method of claim 23, wherein the interim ranking is determined by the scoring algorithm on the host processor and transmits the final ranking to the validation processor.

42. The computerized method of claim 23, wherein the at least one bettor processor is a plurality of bettor processors.

43. A system for providing a parimutuel wagering method for betting on sporting events using pre-compiled teams, comprising:
a host processor programmed for receiving data, analyzing data, creating data, transmitting data, and interactively connecting a plurality of bettors for betting on sporting events;
a plurality of bettor processors programmed to receive data from the host processor, display data from the host processor, accept at least one betting instruction from the plurality of bettors, and transmit the at least one betting instruction to the host processor;
a validation processor programmed for receiving the at least one betting instruction from the host processor, providing a bet validation of the at least one betting instruction to the host processor, calculating the interim and the final odds, and transmitting the interim and the final odds to the host processor,
the processors programmed to:
acquire individual athlete statistics from a provider;
generate a plurality of teams using the individual athlete statistics;
generate initial odds for each of the teams;
combine the initial odds and the teams for display to the plurality of bettors;
display the teams with initial odds for the plurality of bettors to choose at least one of the teams upon which to wager a bet, whereby the initial odds become an interim odds that change over regular intervals of time for the duration of a betting window;
display to the plurality of bettors a wager list for selecting a wager type;
collect at least one bet from the plurality of bettors and providing a bet validation;
close the betting window at a predetermined time before a beginning of the sporting events and displaying a final odds for each of the teams;
acquire data from the provider for each of the plurality of teams;
process the data through a scoring algorithm for assigning an interim ranking to each of the teams, and displaying the interim ranking to the bettor;
calculate a final ranking for each of the teams upon a conclusion of all sporting events associated with the bets that were wagered;
calculate an amount of payout for each of the wagers in parimutuel style and paying the bettors.

44. The system of claim 43, wherein the pre-compiled teams are formed from athletes competing in team-based sporting events.

45. The system of claim 43, wherein the team-based sporting events comprise baseball, football, basketball, hockey, soccer and e-Sports.

46. The system of claim 43, wherein the pre-compiled teams are formed from athletes competing in individual-based sporting events.

47. The system of claim 46, wherein the individual-based sporting events comprise golf, automobile racing, tennis, and e-Sports.

48. The system of claim 43, wherein the athlete is a professional.

49. The system of claim 43, wherein the host processor, the plurality of bettor processors, and the validation processor interact by means of the Internet.

50. The system of claim 43, wherein the plurality of bettor processors are connected to the host processor by means of a wireless Internet connection.

51. The system of claim 43, wherein the host processor is connected to the validation processor by means of a wireless Internet connection.

52. The system of claim 43, wherein each of the plurality of bettors pay their bet amount via an electronic payment method.

53. The system of claim 43, wherein the wager type comprises horserace-style wagers.

54. The system of claim 43, wherein the final odds are calculated by an odds algorithm being
Final Odds=((total pool)*(take percent)−(amount bet on a pre-compiled team))/(team pool)

55. The system of claim 43, wherein the plurality of bettors are paid via an electronic payment method.

56. The system of claim 43, wherein the data created by the host processor comprises the interim ranking and final ranking via the scoring algorithm.

57. The system of claim 43, wherein the final ranking is transmitted to the validation processor for calculating the amount of payout.

58. The system of claim 43, wherein the bet validation is identified with a unique number.

59. The system of claim 43, wherein the interim ranking is determined by the scoring algorithm on the host processor and transmits the final ranking to the validation processor.
